(19) United States
(12) Patent Application Publication
(10) Pub. No.: US 2008/0082647 A1
(43) Pub. Date: Apr. 3, 2008

(54) Connection reservation in dynamic node allocation computing environments

(76) Inventor: Dennis Baker, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/540,119

(22) Filed: Sep. 29, 2006

(51) Int. Cl. G06F 15/173

(52) U.S. Cl. 709/223

(57) ABSTRACT

Exemplary computer system architectures and methods are described. In one embodiment, a computer network comprises a computing engine including a plurality of compute nodes, and a load balancer coupled to the computing engine and coupled to a processor and a memory module, wherein the memory module comprises logic instructions, which, when executed by the processor, configure the processor to receive, in the load balancer, a connection request from a first client computing device associated with a first persistence identifier for computing services provided by a compute node managed by the load balancer, assign the connection request from the first client computing device to a first compute node, and prevent the first compute node from receiving a subsequent connection request associated with a second persistence identifier, different from the first persistence identifier.

### BACKGROUND

Computing networks may be populated with servers and client computers. Servers are generally more powerful computers that provide common functions such as record sharing and Internet access to the client computers. Client computers may be fully functional computers, each having a processor, hard drive, CD ROM drive, floppy drive and system memory.

Recently, thin client computing devices have become more popular among IT organizations. Compared to fully functional client computers, thin clients may have only a relatively small amount of system memory and a relatively slow processor. However, thin clients provide several advantages over fully functional client computers. For example, thin clients may be more reliable than their fully functional client computers, which in turn reduces maintenance costs.

Thin clients may be connected over a network to a central server. The thin client computer may communicate with the central server via a multi-user terminal server application program. The central server may provide a virtualized operating system for the thin clients connected to it. Additionally, the central server may supply application programs such as, e.g., word processing or Internet browsing to the thin clients. A user's data such as, e.g., document files, spreadsheets and Internet favorites, may be stored on the central server or network storage device coupled to the central server. Thus, when a thin client breaks, it may be easily removed and replaced without the need to restore the user's programs and data such as with a traditional fully functional client computer.

Problems may arise when a user of a thin client connected to a central server through a multi-user terminal server application begins execution of a process that requires a relatively large amount of computing power. For example, if the central server is unable to effectively distribute the computing load required by the process, then other thin client users connected to the central server through the terminal server application may experience performance problems because a significant portion of the power of the central server is being diverted to process the needs of a single user.

A central server may contain one or more blade computers such as, e.g., the HP BladeSystem product line available from the assignee of the present application, which are ultra-dense, low power blade computers designed to provide a high level of computing power in a relatively small space. In some applications hundreds of blade computers may be mounted in a single rack.

Because blade computers consume less space, power, and produce less heat than conventional rack-mounted computers, they may result in significant cost savings. Additionally, blade computers may be connected in parallel to form computing engines of immense power. An effective way to employ blade computers in a network architecture is desirable.

### BRIEF DESCRIPTION OF THE DRAWINGS

FIG. 1 is a block diagram of an example client-server computer network architecture according to an embodiment.

FIG. 2 is a block diagram of and example of a network architecture according to an embodiment.

FIGS. 3-5 are flowcharts illustrating operations in a method for implementing connection reservation in a dynamic node allocation computing environment according to embodiments.

FIG. 6 is a schematic illustration of an embodiment of a data table.

### DETAILED DESCRIPTION

Described herein are exemplary computing environment architectures and methods for connection reservation in dynamic node allocation computing environments. The methods described herein may be embodied as logic instructions on a computer-readable medium. When executed on a processor, the logic instructions cause a computing device to be programmed as a special-purpose machine that may implement the described methods. The processor, when configured by the logic instructions to execute the methods recited herein, constitutes structure for performing the described methods.

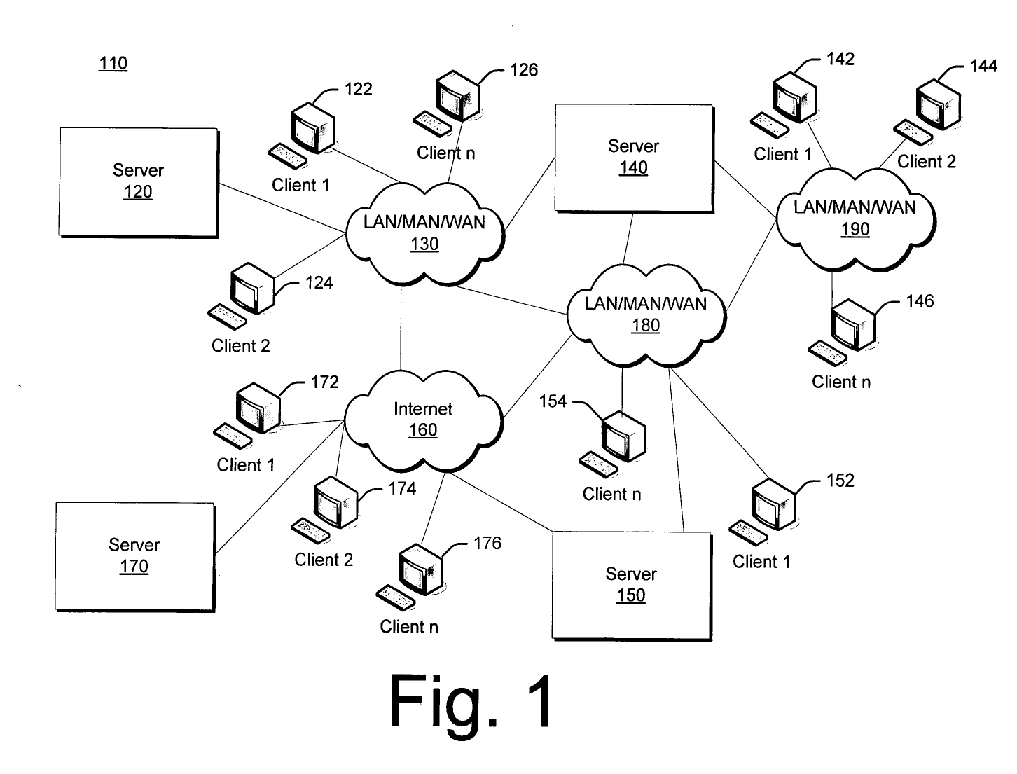

FIG. 1 is a schematic illustration of a block diagram of a computer network 110. The computer network 110 is intended to illustrate a conventional client-server network configuration. A server 120 is connected to a plurality of fully functional client computers 122, 124 and 126 via a communication network 130 such as a Local Area Network (LAN), Metropolitan Area Network (MAN) or a Wide Area Network (WAN) or the like.

The server 120 may be connected to a plurality (n) client computers. Each client computer in the network 110 may be implemented as a fully functional client computer or as a thin client computing. The magnitude of n may be related to the computing power of the server 120. If the server 120 has a high degree of computing power (for example, fast processor(s) and/or a large amount of system memory) relative to other servers on the network, it will be able to effectively serve a relatively large number of client computers.

The server 120 is connected via a network infrastructure 130, which may comprise any combination of hubs, switches, routers and the like. While the network infrastructure 130 is illustrated as being either a LAN, WAN, or MAN, those skilled in the art will appreciate that the network infrastructure 130 may assume other forms such as, e.g., the Internet or any other intranet. The network 110 may include other servers and clients, which may be widely dispersed geographically with respect to the server 120 and to each other to support fully functional client computers in other locations.

The network infrastructure 130 connects the server 120 to server 140, which is representative of any other server in the network environment of server 120. The server 140 may be connected to a plurality of client computers 142, 144 and 146 over network 190. The server 140 is additionally connected to server 150 via network 180, which is in turn is connected to client computers 152 and 154 over network 180. The number of client computers connected to the servers 140 and 150 is dependent on the computing power of the servers 140 and 150, respectively.

The server 140 is additionally connected to the Internet 160 over network 130 or network 180, which is in turn, is connected to server 170. Server 170 is connected to a plurality of client computers 172, 174 and 176 over Internet 160. As with the other servers shown in FIG. 1, server 170 may be connected to as many client computers as its computing power will allow.

Those of ordinary skill in the art will appreciate that servers 120, 140 150 and 170 need not be centrally located. Servers 120, 140, 150 and 170 may be physically remote from one another and maintained separately. Many of the client computers connected with the network 110 have their own CD-ROM and floppy drives, which may be used to load additional software. The software stored on the fully functional client computers in the network 110 may be subject to damage or misconfiguration by users. Additionally, the software loaded by users of the client computers may require periodic maintenance or upgrades.

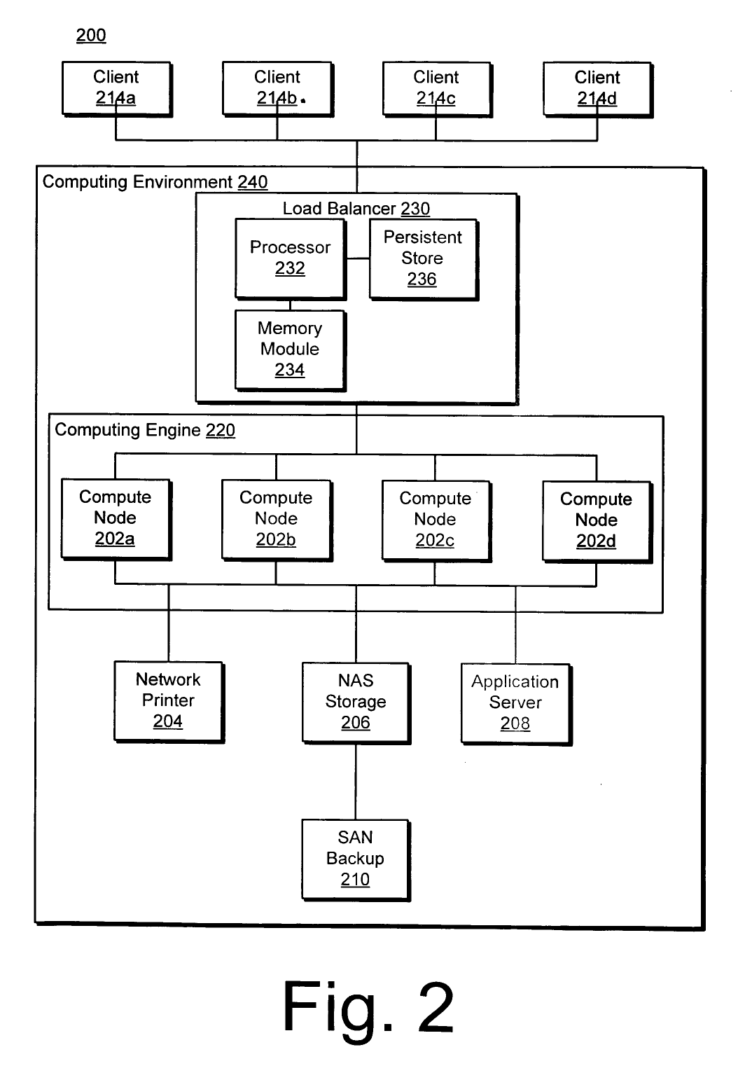

FIG. 2 is a block diagram of an example of a computer network architecture. The network architecture is referred to generally by the reference numeral 200. In one embodiment, a plurality of client computing devices 214a-214d are coupled to a computing environment 240 by a suitable communication network.

Within computing environment 240 a plurality of compute nodes 202a-202d are coupled to form a central computing engine 220. Compute nodes 202a-202d may be referred to collectively by the reference numeral 202. Each compute node 202a-202d may comprise a blade computing device such as, e.g., an HP bc1500 blade PC commercially available from Hewlett Packard Corporation of Palo Alto, Calif., USA. Four compute nodes 202a-202d are shown in the computing environment 240 for purposes of illustration, but compute nodes may be added to or removed from the computing engine as needed. The compute nodes 202 are connected by a network infrastructure so that they may share information with other networked resources and with a client in a client-server (or a terminal-server) arrangement.

The compute nodes 202 may be connected to additional computing resources such as a network printer 204, a network attached storage device 206 and/or an application server 208. The network attached storage device 206 may be connected to an auxiliary storage device or storage attached network such as a server attached network back-up device 210.

The compute nodes 202 are additionally connected to a load balancer 230. In one embodiment, the load balancer 230 may be implemented as a BIG-IP Blade Controller, commercially available from F5 Networks of Seattle, Wash., USA.

In one embodiment, load balancer 230 comprises a processor 232, a memory module 234, and a persistent memory store 236. The processor 232 may further comprise random access memory (RAM) and/or random operational memory (ROM), or other kinds of volatile or non-volatile memory, or some combination thereof. The persistent memory store 236 may be implemented as magnetic storage such as a hard disk drive, optical storage such as a CD-ROM or a DVD-ROM, or some combination of these and other persistent memory devices.

In the embodiment depicted in FIG. 2, the load balancer 230 may be a network traffic load balancer configured to direct (i.e., allocate) certain types of network traffic to the plurality of compute nodes 202. The load balancer 230 may be connected to a plurality of client computers 214 and may be adapted to receive network traffic, including requests to perform computing services then logically track and dynamically direct these connections to one or more compute nodes.

The load balancer 230 may distribute (allocate) requests for computing services among the compute nodes 202 according to any protocol or algorithm. A use-based distribution algorithm is one example of a distribution scheme that may be used by the load balancer 230 to distribute requests for computing services to the compute nodes 202. In a use-based distribution scheme, the load balancer 230 may have the capability to communicate with the compute nodes 202 to determine the relative workload being performed by each of the compute nodes 202. Requests for additional work may be forwarded to a compute node that is under-utilized compared to other compute nodes.

The client computers 214 may comprise thin client computer systems. The load balancer 230 may be coupled to the client computers through a single-user terminal server program such as the single-user terminal server utility that is provided as part of the Microsoft Windows XP operating system, which is available from Microsoft Corporation of Redmond, Wash.

In one embodiment, the computing environment 240 may be adapted to reserve a compute node for a session connection between a client computing device and a compute node in the computing engine 220. By way of example, a client computing device 214a may initiate a connection request for services from one or more of the compute nodes 202. The connection request is received at the load balancer 230, which selects a first compute node, e.g., 202a to which the connection request may be directed. In the event that the connection between client 214a and compute node 202a is disrupted due to, e.g., a network failure, or device failure, the load balancer 230 may reserve the session connection with the compute node 202a for a predetermined period of time to permit the user of client computing device 214a to reestablish the connection. The session may be reestablished from the same client 214a or from a different client such as, e.g., one of other client computing devices 214b-214d.

The structure and operations of computing environment 240 address this issue. In one embodiment, the memory module 234 of load balancer 230 includes logic instructions which, when executed by processor 232, cause the processor to create and maintain a data record in persistent store 236 or memory module 234. The data record associates a session identifier associated with a connection with an identifier that identifies the compute node to which the connection request is assigned by the allocation engine 230. In the event that a connection is severed, the compute node to which the connection was assigned may be reserved for a period of time. Connection information stored in the data record may be used by the load balancer 230 to reestablish the session in a connection between the persistent user and the corresponding compute node. The client computing device may be the same client or a different client.

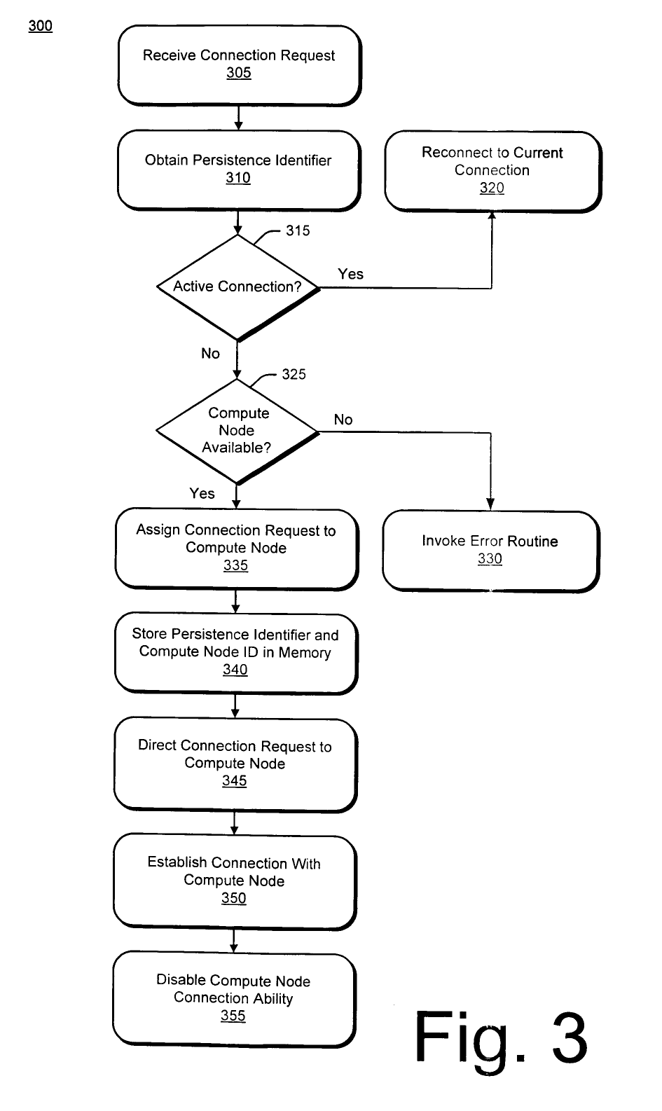

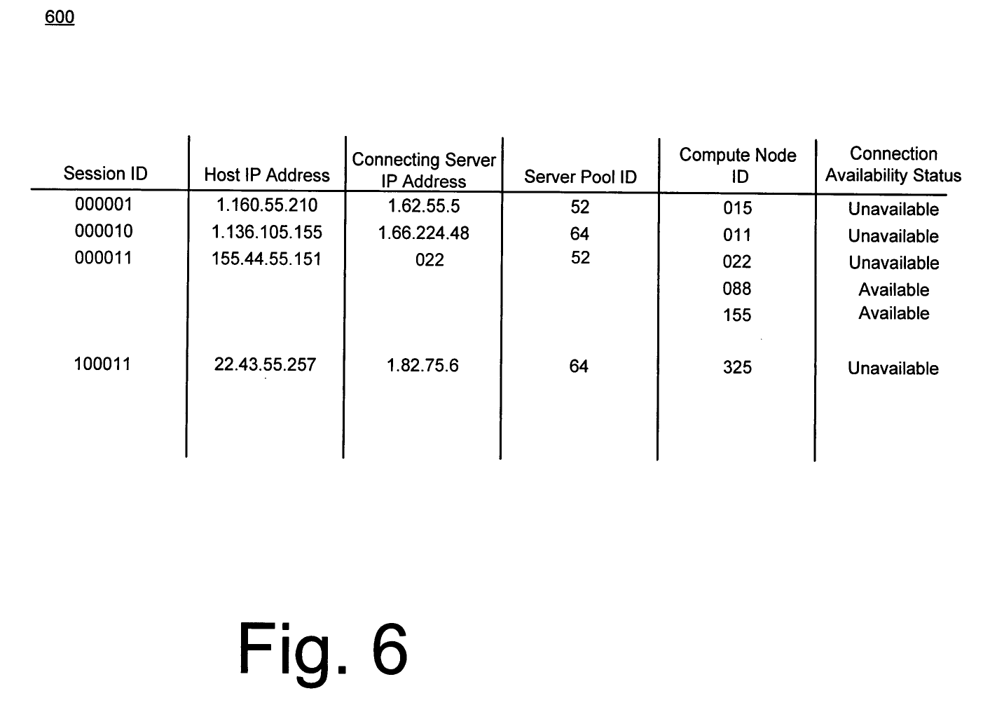

FIGS. 3-5 are flowcharts illustrating operations in a method for implementing connection reservation in a dynamic node allocation computing environment. FIG. 6 is a schematic depiction of one embodiment of a data table. In one embodiment, the operations of FIGS. 3-5 may be implemented by the processor 232 in load balancer 230. Referring to FIGS. 3-6, at operation 305 a connection request is received from a client computing device such as one of the thin client computing devices 214. In one embodiment, the connection request may include a persistence identifier identifying the computing device which generated the connection request. In one embodiment, the persistence identifier may be embodied as a user name identifier which uniquely identifies a user of client 214. In an alternate embodiment, the persistence identifier may be embodied as a connection request identifier that uniquely identifies a connection request. A persistence identifier may be embodied as, e.g., a sequential identifier assigned by the allocation engine 230 when a connection request is received 305 or any other identifier unique to user of the client 214.

At operation 310 a persistence identifier is obtained. In one embodiment, the persistence identifier may be obtained by, e.g., parsing the identifier from the connection request or by generating a connection identifier in the allocation engine 230. At operation 315 it is determined whether there is an active connection associated with the persistence identifier. In one embodiment, this may be performed by checking to determine whether there is an entry for the persistence identifier in the data record maintained in the persistent memory store 236 or memory module 234.

Referring to FIG. 6, in one embodiment the data table 600 associates a persistence identifier with a compute node ID that identifies the compute node to which the session is assigned. In one embodiment, the data table 600 may include a column for a persistence identifier, the host IP address of the client, the IP address of the virtual server through which the client connected to the computing environment 240, the pool ID of the computing environment 240, a compute node ID, and a connection availability status. To determine whether there is an active connection that matches the persistence identifier, the data table 600 may be searched for a persistence identifier that matches the persistence identifier obtained in operation 310.

If, at operation 315 the persistent identifier is in the data table 600 (i.e., if the connection is active), then control passes to operation 320 and the request is reconnected to the current connection. By contrast, if, at operation 315, the persistence identifier is not in the data table 600, then a persistence identifier may be assigned and stored in memory and control passes to operation 325 and, if no compute nodes are available, then control passes to operation 330 and an error routine may be invoked. In one embodiment the error routine may include generating an error message that may be transmitted to the client which generated the request. In an alternate embodiment, the error routine may include generating a queue into which the connection request may be placed.

By contrast, if at operation 325, one or more compute nodes are available, then control passes to operation 335 and the connection request is assigned to a compute node. At operation 340 the persistence identifier and the compute node ID are stored, e.g., in the table 600. At operation 345 the connection request is directed to the compute node 202 to which it was assigned, and at operation 350 a connection is established between the client and the compute node 202.

At operation 355 the load balancer 230 disables the connection ability for the compute node to which the connection was assigned. In one embodiment, the load balancer sets the connection availability status in the data table 600 to “unavailable.” In some embodiments operation 355 may be performed in conjunction with or before operation 335.

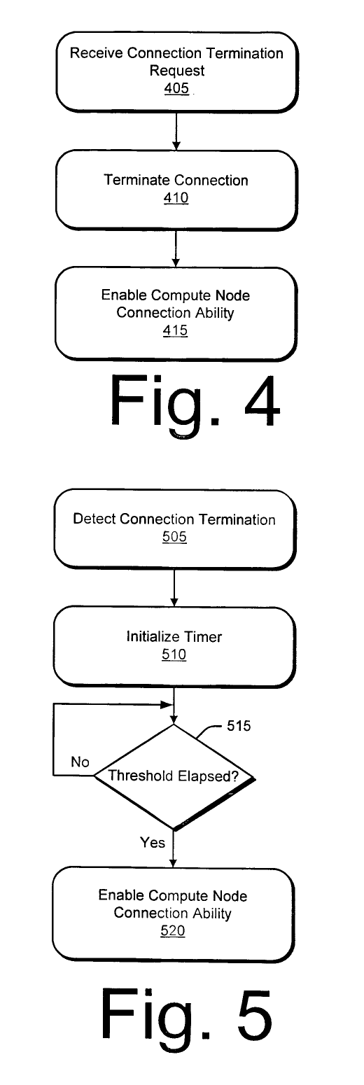

Load balancer 230 may further implement logic instructions which, when executed, configure the processor 232 to change the availability status of a compute node to “available” when the load balancer terminates a connection due to a connection termination request from a client. Referring to FIG. 4, at operation 405 a connection termination request is received in the load balancer 230. In one embodiment the connection termination request may be generated by a user of a client computing device 214 or by the device itself. In response to the termination request, at operation 410 the load balancer 230 terminates the connection between the client computing device 214 and the compute node 202 is terminated. At operation 415 the load balancer 230 enables the compute node's connection ability, e.g., by changing the compute node's ability status parameter in data table 600 to “available.”

Load balancer 230 may further implement logic instructions which, when executed, configure the processor to reserve the compute node for a period of time when a session is terminated by, e.g., a network connection failure or a hardware failure to enable the connection to be reestablished by the same client computing device 214 or by a different client computing device 214. For example, the processor may maintain a lock preventing the first compute node from receiving a subsequent connection request associated with a second persistence identifier different from the first persistence identifier, for a predetermined time period after the first client computing device breaks a connection with the first compute node. Referring to FIG. 5, at operation 505 the load balancer 230 detects a connection termination event. At operation 510, the load balancer 230 initializes a timer. If, at operation 515 the time threshold has elapsed, then control passes to operation 520 and the load balancer 230 enables the compute node's connection ability, e.g., by changing the availability status associated with the compute node in data table 600 to “available.” In one embodiment the time threshold may be implemented as a parameter that may be set, e.g., by a system administrator. In some embodiments the timer can be disabled. The time threshold may be fixed or dynamic. In one embodiment, the session persistence record is deleted when this time threshold expires. This may be completed as a component of session clean up tools used to manage the blade sessions themselves.

The operations of FIGS. 3-5 enable the allocation engine 230 to create and maintain a data table 600 that persistently tracks connection information including the availability status of a compute node, uses the table to enable originating users to re-establish severed connections or take over their active session from a different client computing device without having to worry about a different user inadvertently obtaining their node in their absence.

In the description and claims, the term “coupled” may mean that two or more devices are in direct physical or electrical contact or that two or more devices may not be in direct physical or electrical contact with each other, but yet may still cooperate or interact with each other. For example, two devices may be couples through a third device.

Although the described arrangements and procedures have been describes in language specific to structural features and/or methodological operation, it is to be understood that the subject matter defined in the appended claims is not necessarily limited to the specific features or operations described. Rather, the specific features and operations are disclosed as preferred forms of implementing the claimed present subject matter.

What is claimed is:

1. A computer network, comprising:
a computing engine including a plurality of compute nodes; and
a load balancer coupled to the computing engine and coupled to a processor and a memory module, wherein the memory module comprises logic instructions which, when executed by the processor, configure the processor to:
receive, in the load balancer, a connection request from a first client computing device associated with a first persistence identifier for computing services provided by a compute node managed by the load balancer;
assign the connection request from the first client computing device to a first compute node; and
prevent the first compute node from receiving a subsequent connection request associated with a second persistence identifier, different from the first persistence identifier.

2. The computer network of claim 1, wherein the memory module further comprises logic instructions which, when executed by the processor, configure the processor to receive a connection disable request, wherein the connection disable request identifies the first compute node.

3. The computer network of claim 1, wherein the memory module further comprises logic instructions which, when executed by the processor, configure the processor to record indicia identifying the first compute node and indicia identifying an availability status associated with the first compute node.

4. The computer network of claim 1, wherein the memory module further comprises logic instructions which, when executed by the processor, configure the processor to establish a connection between the first client computing device and the first compute node.

5. The computer network of claim 1, wherein the memory module further comprises logic instructions which, when executed by the processor, configure the processor to maintain a lock preventing the first compute node from receiving a subsequent connection request associated with a second persistence identifier different from the first persistence identifier, for a predetermined time period after the first client computing device breaks a connection with the first compute node.

6. The computer network of claim 1, wherein the memory module further comprises logic instructions which, when executed by the processor, configure the processor to:
receive, in the load balancer, a connection request from the first client computing device for computing services provided by a compute node managed by the load balancer;
reestablish the connection from the first client computing device to the first compute node.

7. The computer network of claim 1, wherein the memory module further comprises logic instructions which, when executed by the processor, configure the processor to assign a persistence identifier to the connection between the first client computing device and the first compute node.

8. A method, comprising:
receiving, in a load balancer, a connection request from a first client computing device associated with a first persistence identifier for computing services provided by a compute node managed by the load balancer;
assigning the connection request from the first client computing device to a first compute node; and
preventing the first compute node from receiving a subsequent connection request from a second client computing device associated with a second persistence identifier, different from the first persistence identifier.

9. The method of claim 8, wherein further comprising disabling a connection ability of the first compute node.

10. The method of claim 8, further comprising recording, in a memory, indicia identifying the first compute node and indicia identifying an availability status associated with the first compute node.

11. The method of claim 8, further comprising establishing a connection between the first client computing device and the first compute node.

12. The method of claim 8, further comprising maintaining a lock preventing the first compute node from receiving a subsequent connection request associated with a second persistence value different from the first persistence identifier, for a predetermined time period after the first client computing device breaks a connection with the first compute node.

13. The method of claim 12, further comprising:
receiving, in the load balancer, a connection request from the first client computing device for computing services provided by a compute node managed by the load balancer;
reestablishing the connection from the first client computing device to the first compute node.

14. The method of claim 8, wherein assigning the connection request from the first client computing device to a first compute node comprises assigning a persistence identifier to the connection between the first client computing device and the first compute node.

15. The method of claim 14, wherein assigning a persistent identifier comprises assigning a persistence identifier that uniquely identifies a user.

16. The method of claim 14, wherein assigning a persistent identifier comprises assigning a persistence identifier that uniquely identifies a connection request.

17. The method of claim 9, further comprising:
terminating the connection between the first client computing device and the first compute node; and
making the first compute node available to receive a connection request from a second client computing device.

18. A computer-readable medium storing a computer program product comprising logic instructions which, when executed on a processor, configure the processor to:
receive, in the load balancer, a connection request from a first client computing device associated with a first persistence identifier for computing services provided by a compute node managed by the load balancer;
assign the connection request from the first client computing device to a first compute node; and
prevent the first compute node from receiving a subsequent connection request associated with a second persistence value different from the first persistence identifier.

19. The computer-readable medium of claim 18, further comprising logic instructions which, when executed by the processor, configure the processor to receive a connection disable request, wherein the connection disable request identifies the first compute node.

20. The computer-readable medium of claim 18, further comprising logic instructions which, when executed by the processor, configure the processor to record, in a memory module, indicia identifying the first compute node and indicia identifying an availability status associated with the first compute node.

21. The computer-readable medium of claim 18, further comprising logic instructions which, when executed by the processor, configure the processor to establish a connection between the first client computing device and the first compute node.

22. The computer-readable medium of claim 18, further comprising logic instructions which, when executed by the processor, configure the processor to maintain a lock preventing the first compute node from receiving a subsequent connection request associated with a second persistence identifier different from the first persistence identifier value, for a predetermined time period after the first client computing device breaks a connection with the first compute node.

23. The computer-readable medium of claim 18, further comprising logic instructions which, when executed by the processor, configure the processor to:
receive, in the load balancer, a connection request from the first client computing device for computing services provided by a compute node managed by the load balancer;
reestablish the connection from the first client computing device to the first compute node.

24. The computer-readable medium of claim 18, further comprising logic instructions which, when executed by the processor, configure the processor to assign a persistence identifier to the connection between the first client computing device and the first compute node.
